(19) United States
(12) Patent Application Publication
(10) Pub. No.: US 2012/0131568 A1
(43) Pub. Date: May 24, 2012

(54) SYSTEM AND METHOD OF PROVIDING SERVICE AGENT

(75) Inventor: Jong Moo SOHN, Daejeon (KR)

(73) Assignee: Electronics and Telecommunications Research Institute, Daejeon (KR)

(21) Appl. No.: 13/299,895

(22) Filed: Nov. 18, 2011

(30) Foreign Application Priority Data
Nov. 23, 2010 (KR) 10-2010-0116876

(51) Int. Cl. G06F 9/44; G06F 9/445

(52) U.S. Cl. 717/172; 717/168

(57) ABSTRACT

Provided are a system and method of providing a service agent for a service execution environment based on user and terminal characteristics. The method includes providing a service agent satisfying a selected service and a verified terminal characteristics to a terminal unit when a user selects a specific service through the terminal unit, and generating or updating a user service list; searching the user service list when there is a request for providing update/re-installation/deletion of the service agent from the terminal unit, and then providing a service agent information list satisfying a verified service being used and the terminal characteristics of the terminal unit; and providing a service agent to the terminal unit to be updated/re-installed, when the user or the terminal unit selects the service agent to be updated/re-installed.

### CROSS-REFERENCE TO RELATED APPLICATIONS

This application claims the priority of Korean Patent Application No. 10-2010-0116876 filed on Nov. 23, 2010, in the Korean Intellectual Property Office, the disclosure of which is incorporated herein by reference.

### BACKGROUND OF THE INVENTION

1. Field of the Invention

The present invention relates to a system and method of providing a service agent, for configuring and providing service execution environments divided by users and types of terminal units by using user and terminal characteristics information.

The present invention was derived from research performed as an IP growth engines technical development business of the Ministry of Knowledge Economy [Subject File No.: K1001845, Subject Name: Integrated-type U-Service Framework Development for Supporting One-Service-Cross-Domain].

2. Description of the Related Art

Multifunctional terminal units providing various services, from which a user can experience various services through one terminal unit, are provided, and furthermore, one user may possess a plurality of multifunctional terminal units.

A user may experience desired services suitable for a user's own situation by selectively using his or her own terminal units, and therefore, respective user terminal units have multiple software programs (hereinafter, referred to as ‘service agents’) installed therein providing services.

Since service agents have the possibility of frequently being updated by a specific service agent provider, a method of automatically updating a plurality of software agents already installed according to respective users using terminal units, and a method of automatically restoring an existing service execution environment to be suitable for corresponding terminal properties when a user moves a service environment to a new terminal unit, are required for easier maintenance and management of terminal units without a user's particular intervention.

A method of using version information of a terminal unit (Korean Patent Laid-Open Publication No. KR2004-0017461) may be used in updating various software programs including terminal firmware. However, since the method performs the updating depending only upon a terminal type without distinction between users, there may be difficulties in establishing a service execution environment appropriate to a specific user environment.

Meanwhile, methods of performing software updating according to users (Korean Patent Laid-Open Publication No. KR2009-0008563, U.S. Patent Application Publication No. US20090193409) are proposed such that service execution environments specialized according to users may be automatically updated, but these methods cannot reflect user terminal characteristics, and thus, they are difficult to apply in a case in which a user moves to other terminal unit having a great difference in characteristics.

In addition, the methods have a defect in which the updating of only preinstalled service agents is supported, instead of completely restoring an overall service execution environment.

### SUMMARY OF INVENTION

An aspect of the present invention provides a system and method of providing a service agent, which is capable of automatically updating various service agents in a service execution environment configured to be suitable for user and terminal characteristics and automatically restoring an existing service execution environment used by a user in a new terminal unit.

According to an aspect of the present invention, there is provided a method of providing a service agent, the method including: verifying a user and a terminal characteristic of a terminal unit; providing a service agent satisfying a selected service and the terminal characteristics to the terminal unit when a user selects a specific service through the terminal unit, and generating or updating a user service list to register a user's use of the selected service; searching the user service list to verify the service being used thereby when there is a request for providing update/re-installation/deletion of the service agent from the terminal unit, and then providing a service agent information list satisfying the verified service and the terminal characteristics of the terminal unit; providing a service agent to the terminal unit to be updated/re-installed, when the user or the terminal unit selects the service agent to be updated/re-installed, based on the service agent information list; and updating or deleting the user service list to thus register services so as to avoid using a service corresponding to a deleted service agent when the user or the terminal unit deletes the service agent on the basis of the service agent information list.

The service list may have a structure in which user information and service information are mapped with each other.

The method of providing a service agent may further include generating and storing a service agent list stating a list of services that are able to be provided according to a service and the terminal characteristic.

The service agent list may have a structure in which the service information, the terminal characteristic, service agent information and the service agent are mapped with one another, wherein the service agent information includes information relating to service agent ID, a service agent version and service agent size.

The providing of the service agent information list may include searching the user service list to verify a service being used by the user; and searching the service agent list, extracting the service agent information satisfying the verified service and the terminal characteristic, generating the service agent information list and then providing the created service agent information list to the terminal unit.

The registering of the user's use of the selected service may include searching the user service list when the user selects the specific service through the terminal unit; providing the service agent satisfying the selected service and the terminal characteristics when there is no user service list, and subsequently, generating a new user service list having information of the user's selected service; and providing the service agent in consideration of the selected service and the terminal characteristics when the user service list is present, and then, adding the selected service information to the user service list.

According to another aspect of the present invention, there is provided a method of providing a service agent for a terminal unit, the method including: providing user and terminal characteristics to a server, and subsequently receiving a service agent information list satisfying the user and terminal characteristics; when a service agent to be updated/re-installed is selected based on the service agent information list, notifying the server of the selection and receiving the service agent to be updated/re-installed from the server to then update/re-install the received service agent; and when a service to be newly installed is selected, notifying the server of the selection and receiving a service agent satisfying the newly installed service and the terminal characteristics from the server to thus install the received service agent.

The receiving and updating of the service agent may include comparing a version of a service agent included in the service agent information list with a version of a service agent pre-installed in the terminal unit; selecting a service agent necessary for an updating operation to thus notify the selection by reflecting a comparison result; and receiving the service agent necessary for the updating operation from the server to thus update the received service agent.

According to another aspect of the present invention, there is provided a server including: a user service list storage unit storing list of services currently being used by each user; a service agent storage unit storing a list of service agents able to be provided according to each service and individual terminal characteristics; a connection management unit supporting a terminal connection and verifying user and terminal characteristics information from a terminal unit; an agent manager providing the service agent in consideration of the user characteristics information, the terminal characteristics information, and a service requested by the terminal unit; and a service manager generating the service list and the service agent list and reflecting an operation of the agent manager in the service list.

The service agent list may have a structure in which service information, the terminal characteristics, service agent information and the service agent are mapped with each other, wherein the service agent information includes information on service agent ID, a service agent version and service agent size.

The user service list may have a structure in which user information and the service information are mapped with each other.

When the user or the terminal unit selects a specific service, the agent manager may acquire and provide the service agent based on the service information and the terminal characteristics of the terminal unit And when the terminal unit requests a service agent information list, the agent manager may extract the service agent information corresponding to all services included in the user service list and the terminal characteristics, from the service agent list, to thus create and provide the service agent information. Also when the user or the terminal unit selects a service agent to be updated/re-installed by using the service agent information list, the agent manager may acquire and provide the service agent to be updated/re-installed.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram of a system for providing a service agent according to an embodiment of the present invention;

FIGS. 2 and 3 are diagrams illustrating a structure of a service list and a service agent list according to an embodiment of the present invention;

FIG. 4 is a drawing illustrating an operating method in a system for providing a service agent when a user first configures a service execution environment in a user's terminal unit according to an embodiment of the present invention;

FIG. 5 is a drawing explaining an operating method in a system for providing a service agent when a new version of a specific service agent is available and a user's service execution environment is updated according to an embodiment of the present invention;

FIG. 6 is a drawing explaining an operating method in a system for providing a service agent in a case in which a user moves to a different terminal unit to re-establish an overall service execution environment therein according to an embodiment of the present invention; and

FIG. 7 is a drawing explaining an operating method in a system for providing a service agent when a user arbitrarily deletes a service agent from a terminal unit according to an embodiment of the present invention.

### DETAILED DESCRIPTION OF THE INVENTION

The present invention may be variably modified and may have various embodiments, particular examples of which will be illustrated in drawings and described in detail.

However, it should be understood that the following exemplifying description of the invention is not intended to restrict the invention to specific forms of the present invention but rather the present invention is meant to cover all modifications, similarities and alternatives which are included in the spirit and scope of the present invention.

The terms used in the present application are merely used to describe particular embodiments, and are not intended to limit the present invention. An expression used in the singular encompasses the expression of the plural, unless it has a clearly different meaning in the context in which it is used. In the present application, it is to be understood that terms such as “including” or “having,” etc., are intended to indicate the existence of features, numbers, operations, actions, components, parts, or combinations thereof disclosed in the specification, and are not intended to preclude the possibility that one or more other features, numbers, operations, actions, components, parts, or combinations thereof may exist or may be added.

Unless otherwise defined, all terms used herein, including technical or scientific terms, have the same meanings as those generally understood by those with ordinary knowledge in the field of art to which the present invention belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

Embodiments of the present invention will be described below in detail with reference to the accompanying drawings, where those components that are the same or are in correspondence are referred to by using the same reference number, regardless of the figure number, and redundant explanations are omitted.

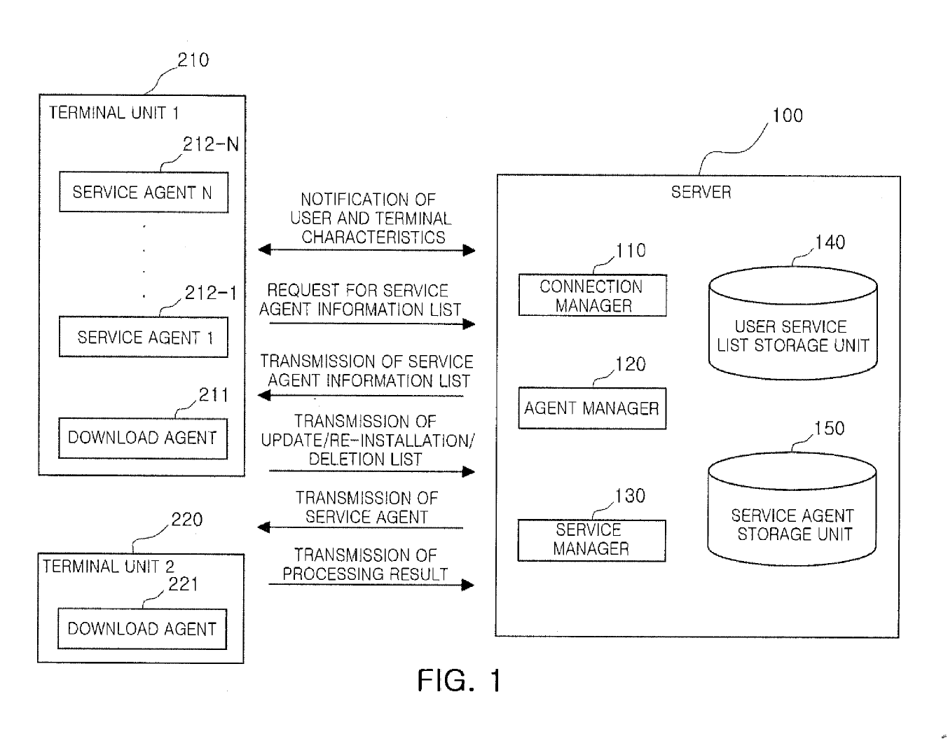

FIG. 1 is a block diagram of a system for providing a service agent according to an embodiment of the present invention.

Referring to FIG. 1, a system for providing a service agent may include a server 100 and a plurality of terminal units 210 and 220 capable of being used by the same user.

The terminal units 210 and 220 may respectively include download agents 211 and 221 that interact with the server 100 to install/update/re-install/delete service agents 212-1 to 212-N.

The server 100 may include a connection manager 110, an agent manager 120, a service manager 130, a user service list storage unit 140 and a service agent storage unit 150.

The connection manager 110 may handle a connection from a terminal unit, e.g., 210, and may retrieve user characteristics and terminal characteristics of the terminal unit 210.

When a user requests to install a specific service through the terminal unit 210 being currently used, the agent manager 120 may provide a service agent satisfying an installation-requested service and the terminal characteristics of the terminal unit 210 and create or update a user service list to then register a use of the installation-requested service.

When the user requests a/an update/re-installation/deletion of a service agent, the agent manager may verify a service agent that is currently being used by the user and that is capable of being executed in the currently used terminal unit 210 and subsequently notify the currently used terminal unit 210 of the verified service agent. When the terminal unit 210 selects the service agent to be updated/re-installed in response to the notification, the agent manager may provide the service agent to be updated/re-installed to the terminal unit 210. On the other hand, when the user or the terminal unit 210 selects a service agent to be deleted, the agent manager may update the user service list so that a service corresponding to the deleted service agent is removed from the user service list.

The service manager 130 may reflect an operation result from the agent manager 120 to thus create or manage a user service list. In addition, the service manager 130 may register or update a service agent by a service agent provider (not shown), and then create or manage a service agent list informing a service agent of information corresponding to both service and terminal characteristics.

The user service list storage unit 140 may store the user service list and the service agent storage unit 150 may store the service agent list.

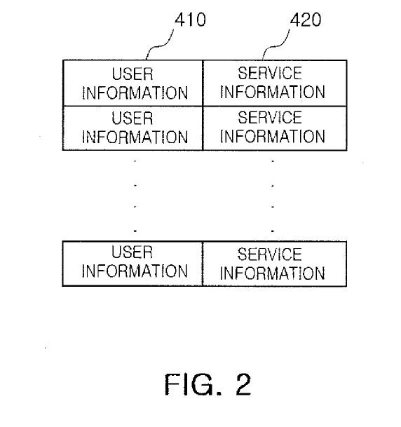

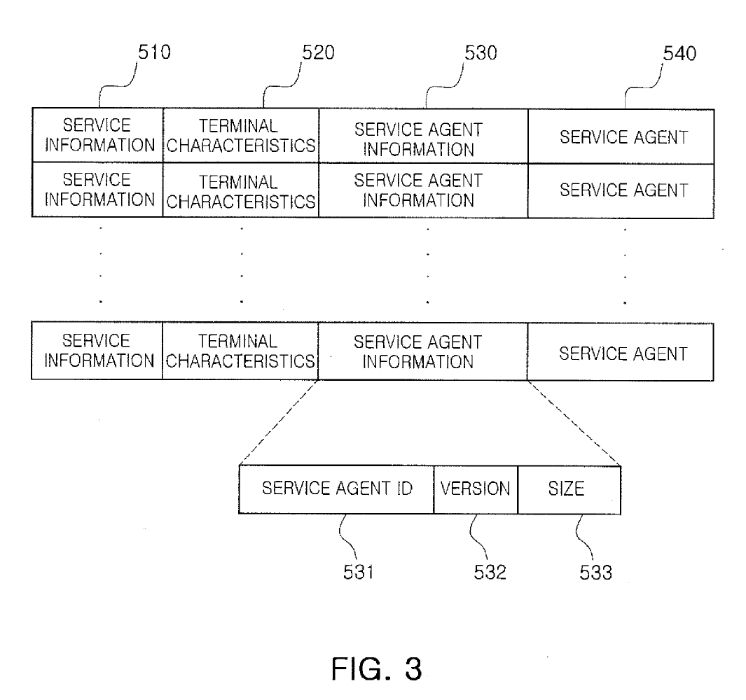

FIGS. 2 and 3 are drawings illustrating structures in a service list and a service agent list according to an embodiment of the present invention.

The user service list stored in the user service list storage unit 140 may indicate a service currently being used by an individual user, in which user information 410 and service information 420 are mapped with each other to thus constitute one item.

Thus, according to an embodiment of the present invention, the user may obtain information of services that are installed and currently being used in all of the user's terminal units by searching the user service list storage unit 140 using the user information 410.

Since the service information 420 is expressed to be consistent to service information 510 used in the service agent storage unit 150, the service information 420 of the user service list storage unit 140 may be used to search for service agents providing a corresponding service in the service agent storage unit 150.

When a specific service agent is registered to the server 100, a service agent provider may together designate terminal characteristics of the terminal unit in which a corresponding service agent can be executed. For example, a terminal unit such as an iPhone, an Android Phone or a Symbian Phone, in which a corresponding service agent can be executed, may be designated and each kind may be indicated as a unique ID form.

The service agent list stored in the service agent storage unit 150 may have a structure in which information for a service supported by a corresponding service agent, that is, the service information 510, terminal characteristics designated by a service agent provider, service agent information 530 and a service agent 540 are mapped with one another. The service agent information 530 may include an ID 531, a version 532, size 533, or the like, of a corresponding service agent 540.

However, the service information 420 stored in the user service list storage unit 140 and the service information 510 stored in the service agent storage unit 150 may be expressed equally to each other. That is, service agents providing a corresponding service may be searched in the service agent storage unit 150 by using the service information 420 stored in the user service list storage unit 140.

As such, the system for providing a service agent according to an embodiment of the present invention may include a user service list informing of services used by each user and a service agent list according to service and terminal characteristics of the user.

As a result, even in a case in which a user moves to a different terminal unit, the system for providing a service agent according to the embodiment of the present invention may find a service list used by the user in existing terminal and provide a service agent capable of equally supporting the service (s) used in the existing terminal unit and also being executed in the moved terminal unit. That is, even in a case in which the user moves service environments to a different terminal unit, an execution environment established (downloaded/installed) by a user in an existing terminal may be automatically re-established in the different terminal unit.

In addition, in the system for providing a service agent, when the user connects to the server, through a terminal unit, a service agent information list corresponding to combined user/terminal characteristics may be created using corresponding user and terminal characteristics, and the created list may be compared with information of service agents installed in the terminal unit and then service agents required to be updated may be automatically updated. That is, when a new version of a service agent among service agents within the service execution environment established by the user is found, a service execution environment may be automatically updated to reflect update of the service agent.

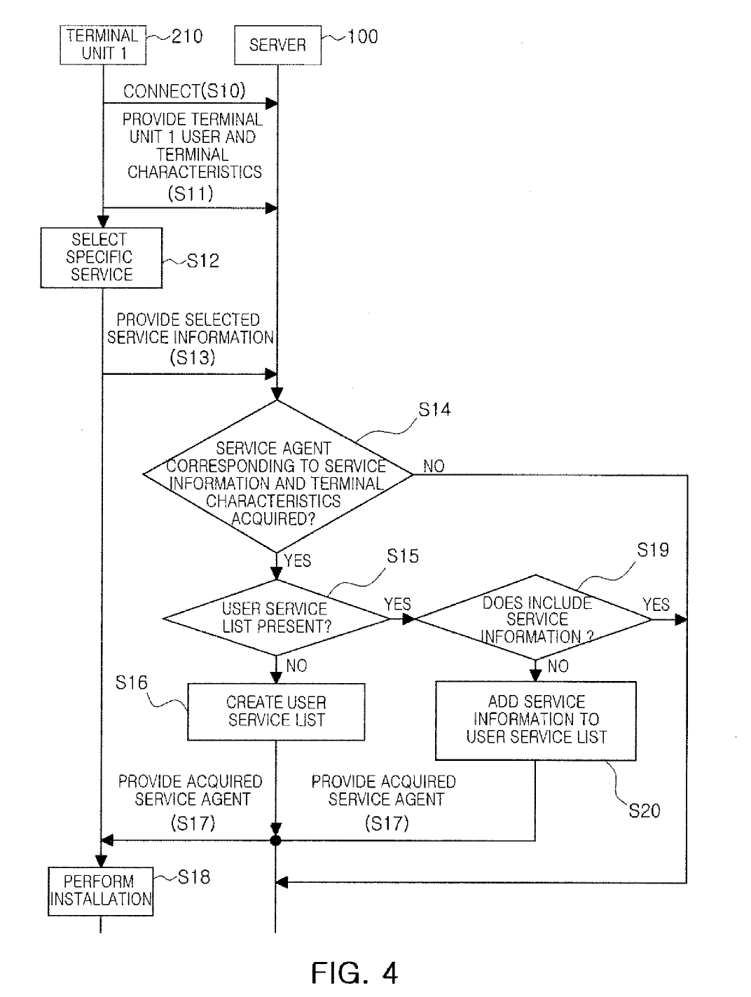

Hereinafter, various operation methods in a system for providing a service agent according to an embodiment of the present invention will be described with reference to FIGS. 4 to 7.

FIG. 4 is a drawing illustrating an operating method in a system for providing a service agent when a user first configures a service execution environment in user's terminal unit according to an embodiment of the present invention.

When the user connects to the server 100 through the terminal unit 1 210 in operation S10, the download agent 211 of the terminal unit 1 210 may provide user and terminal characteristics of the terminal unit 1 to the server 100 in operation S11.

Operation S11 may be performed such that the terminal unit 1 210 unilaterally provides information, or the terminal unit 1 210 provides information in response to the request of the server 100.

For reference, the terminal characteristics may be a collection of attributes for distinction between terminal units and belong to conditions for executing service agents 212-1 to 212-N and may be described such that a difference in conditions in respective terminal units for driving the service agents 212-1 to 212-N can be shown. Terminal characteristics information transmitted from the terminal unit 1 210 may be more in detail, and the server 100 may analyze corresponding information and then define and use a representative terminal characteristics name. For example, the server 100 may represent terminal characteristics by using a representative value such as iPhone, Android Phone, Symbian Phone, or the like. That is, characteristics information transmitted from the terminal unit 1 210 to the server 100 may be represented to be different from characteristics information used by the server.

When the terminal unit 1 210 is preset to automatically perform an update of service agents immediately after connecting to the server 100, the download agent 211 of the terminal unit 1 210 may request the agent manager 120 of the server 100 for a service agent information list. The agent manager 120 may search the user service list storage unit 140, based on the user information of the terminal unit 1 210. However, since there may be no record in which the user selects a specific service in current operation, no output may be provided from the above-mentioned search. Thus, the agent manager 120 cannot retrieve the service agent information list but can inform the download agent 211 of the terminal unit 1 210 that the list does not exist. The download agent 211 does not perform any particular operation in response thereto.

Thereafter, when the user searches the service list through a user interface (UI) included in the terminal unit 1 210, or the like and then selects a specific service in operation S12, the download agent 211 may inform the service manager 130 of the server 100, of selected service information, in operation S13.

The service manager 130 having received the service information may search the service agent storage unit 150 to thus acquire a service agent corresponding to the service and terminal characteristics verified in operations S13 and S11. That is, the service agent that both supports the service requested by the terminal unit 1 210 and is capable of being executed in the terminal unit 1 210 may be obtained in operation S14. In the case of a failure to acquire the service agent, no execution engine is installed in the terminal unit and an overall operation thereof is ended. A method of informing a user of a corresponding fact through a UI or the like may also be used.

When the service agent is obtained in operation S14, the service manager 130 may search the user service list storage unit 140, based on the user information of the terminal unit 1 210 to thus acquire the user service list in operation S15.

When there is no user service list, the service manager 130 may create a new user service list by mapping the user and service information received in operations S11 and S13 with each other, and then store the new user service list in the user service list storage unit 140 in operation S16. Then, the service agent acquired through the agent manager 120 and the download agent 211 in operation S14 may be installed in the terminal unit 1 210, in operations S17 and S18.

Meanwhile, when there is a user service list present, the service manager 130 may search the user service list to verify whether the service information received in operation S13 is included therein, in operation S19.

When a user service list is present but corresponding service information is not included therein, the corresponding service information may be added to the user service list in operation S20, and thereafter, the service agent acquired in operation S14 may be installed in the terminal unit 1 210 through the agent manager 120 and the download agent 211, in operations S17 and S18.

In a case in which the corresponding service information is already included in the user service list, since it indicates that a corresponding service agent has already been installed in the terminal unit 1 210, an operation of transmitting the service agent to the terminal unit may not be performed.

When the service selection operation described above is repetitively performed, at least one or more service agents may be downloaded/installed in the user terminal unit, and information relating to the service currently being used by each user may be recorded in the user service list from the server.

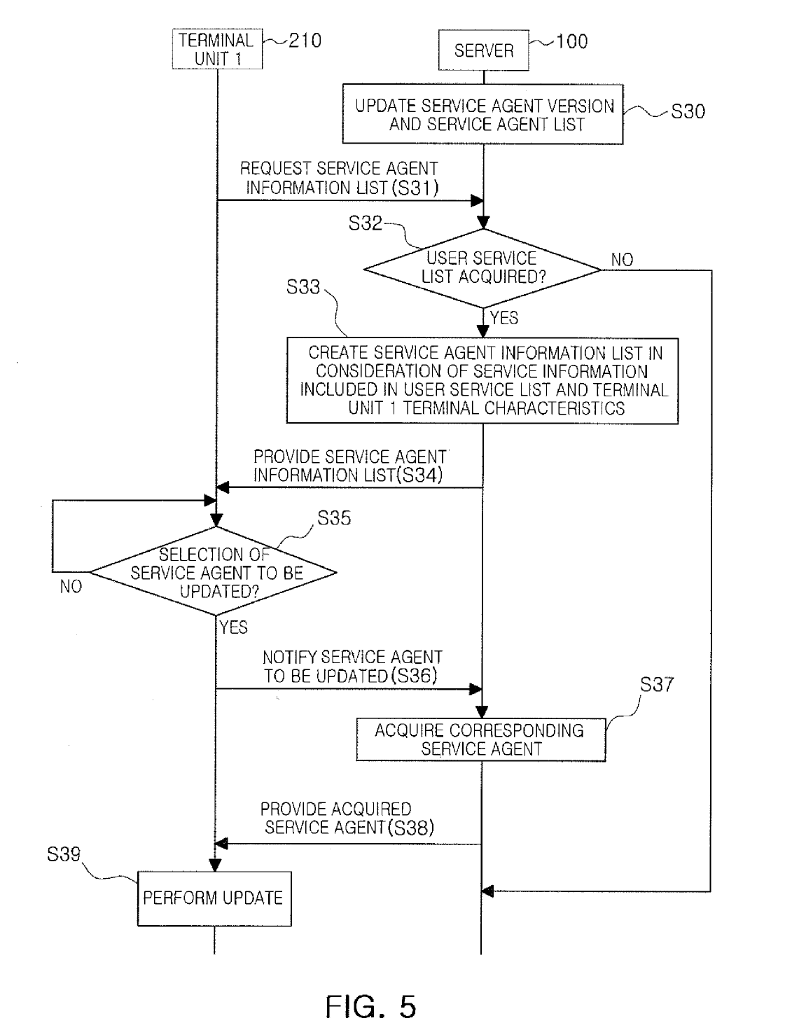

FIG. 5 is a drawing explaining an operating method in a system for providing a service agent when a specific service agent is updated and a user's service execution environment is updated according to an embodiment of the present invention.

When a specific service agent is updated by a service agent provider, the service manager 130 of the server 100 reflects the new contents to update the service agent list. That is, the service agent information 530 of the service agent list corresponding to the new service agent, and the service agent 540 may be changed in operation S30.

Then, in order to perform an updating operation for a specific service agent when the user is connected to the server 100 through the terminal unit 1 210, the download agent 211 of the terminal unit 1 210 may request the service agent information list to be provided in operation S31, and the agent manager 120 of the server 100 may search the user service list storage unit 140, based on the user information of the terminal unit 1 210 to thus acquire the corresponding user service list in operation S32.

Further, the agent manager 120 may search the service agent storage unit 150 by using the service information included in the user service list and the terminal characteristics of the terminal unit 1 210 to verify service agents capable of being executed in the terminal unit 1 210, and subsequently, may extract information from these service agents to create a service agent information list in operation S33 and then provide the created list to the download agent 211 of the terminal unit 1 210 in operation S34.

The download agent 211 may compare versions of the installed service agents with contents of the service agent information list to thus find a service agent required for the updating operation. Then, when a user's intention or the like is reflected automatically or through the UI to thus finally select the service agent to be updated in operation S35, the download agent 211 may notify the agent manager 120 of the corresponding service agent in operation S36.

The agent manager 120 may read a corresponding service agent from the service agent storage unit 150 in operation S37 and then provide the read service agent to the download agent 211 in operation S38, such that the download agent 211 updates the service agent in operation S39.

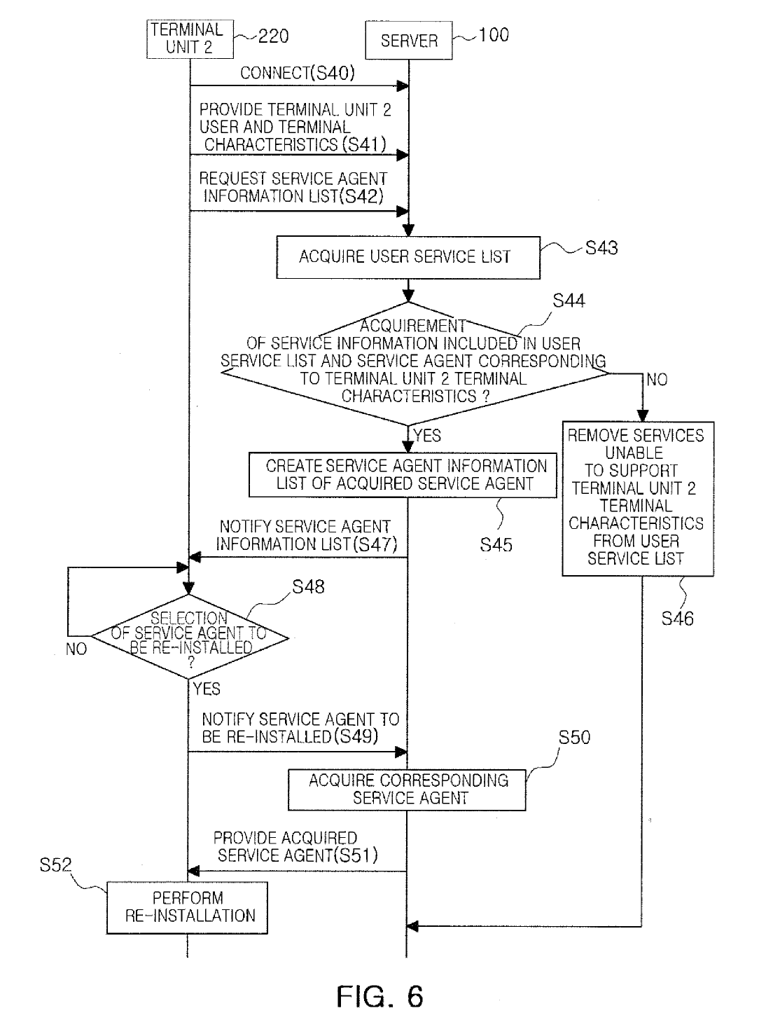

FIG. 6 is a drawing explaining an operating method in a system for providing a service agent when a user moves to a different terminal unit to re-establish an overall service execution environment therein according to an embodiment of the present invention.

When the user moves to a terminal unit 2 220 in which no service agent is installed and connects to the server 100 through the terminal unit 2 220 in operation S40, the download agent 221 of the terminal unit 2 220 may provide user and terminal characteristics information to the server 100.

Thereafter, the download agent 211 may request a service agent information list in operation S42, and the agent manager 120 of the server 100 may search the user service list storage unit 140 in response to the request to thus acquire a service list corresponding to the user of the terminal unit 2 220 in operation S43. Since the service list having been used by the same user in the previous terminal unit 210 is stored in the user service list storage unit 140, the agent manager 120 may acquire the same service list as the previous list.

Then, the service agent storage unit 150 may be searched based on service information included in the user service list and terminal characteristics of the terminal unit 2 220 currently being used by the user, and then, a service agent capable of being executed in the terminal 2 220, among the service agents being used by the user, may be selectively acquired in operation S44.

When the service agents executable by the terminal unit 2 220 are acquired, information relating to the service agents may be extracted from the service agent list to create a service agent information list in operation S45 and then the created service agent information list may be provided to the download agent 211 of the terminal unit 210. When the service agent executable by the terminal unit 2 220 is not acquired, nothing is added to the service agent information list in operation S46.

In a case in which effective service agent information is not present in the service agent information list received from the terminal unit 210, since it indicates that there is no more information to be processed, all operations may end.

In a case in which the effective service agent information is present in the service agent information list received from the terminal unit 210, when the user selects a service agent to be re-installed by using the service agent information list in operation S48, the download agent 211 of terminal unit 2 220 may inform the agent manager 120 of the server 100 of the service agent to be re-installed in operation S49.

Then, the agent manager 120 may read a corresponding service agent from the service agent storage unit 150 in operation S50 and provide the read agent to the download agent 211 in operation S51, such that the download agent 211 may reinstall the service agent in operation S52.

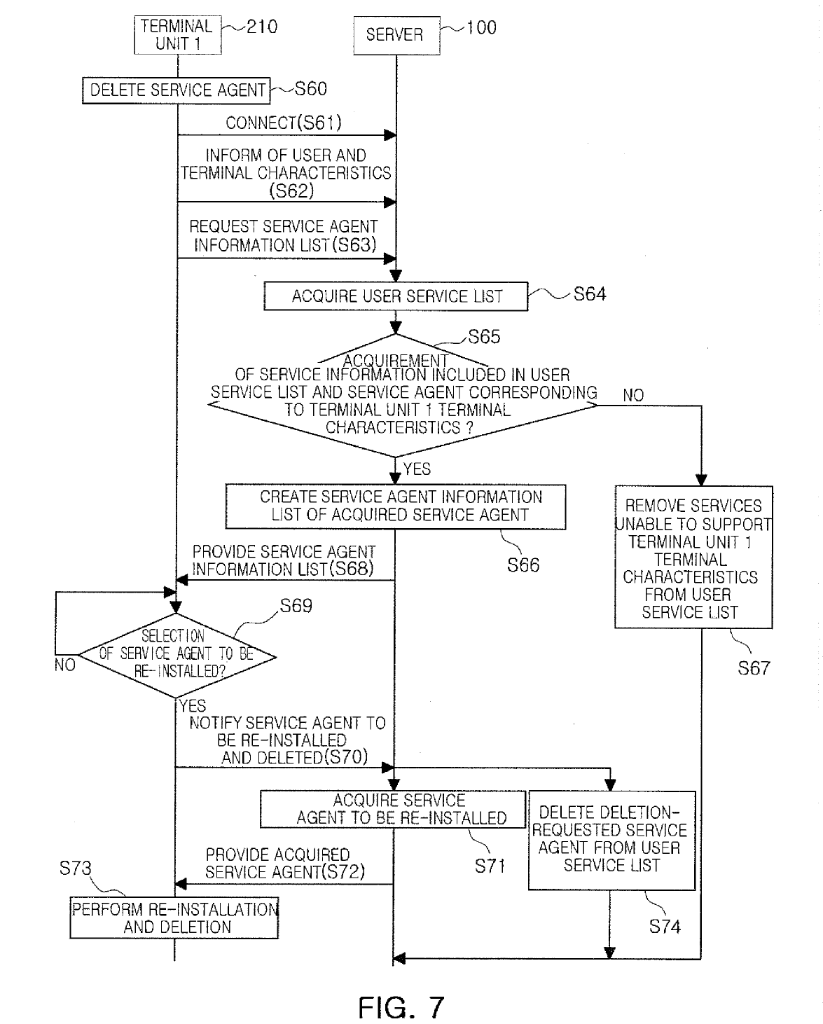

FIG. 7 is a drawing explaining an operating method in a system for providing a service agent when a user arbitrarily deletes a service agent from a terminal unit according to an embodiment of the present invention.

When the user arbitrarily deletes at least one or more of the service agents installed in the terminal unit 1 210, inconsistency between contents of the user service list of the server 100 and lists of the agents installed in the terminal unit 1 210 may occur. In this situation, when the terminal unit 1 210 connects to the server in operation S61, the download agent 211 may determine whether to re-install the already deleted service agent on the basis of the service agent list received from the server 100 in operations S62 to S69, similarly to the service agent re-installation case. When it is determined whether to re-install the already deleted service agent by reflecting a user's intention or the like through the UI in operation S69, the download agent 211 may simultaneously inform the agent manager 120 of the service agent to be re-installed and the service agent to be deleted in operation S70.

The agent manager 120 may provide the service agents to be re-installed to the terminal unit 1 210 in operations S71 to S73, and at the same time, may search the service agent storage unit 140 on the basis of the service agent to be deleted to thus extract service information relating thereto and then search the user service list storage unit 140 to thus remove the extracted service information from the corresponding user service list in operation S74.

As set forth above, in a system and method of providing a service agent according to an embodiment of the present invention, a scheme of automatically managing a version of service agents in a service execution environment established by a user may be provided. In addition, even in the case in which a user moves service environments to a different terminal unit, an execution environment of a user's existing terminal unit established/downloaded/installed by the user may be automatically established in a new terminal unit.

While the present invention has been shown and described in connection with the embodiments in the, it will be apparent to those skilled in the art that modifications and variations can be made without departing from the spirit and scope of the invention as defined by the appended claims.

What is claimed is:

1. A method of providing a service agent, the method comprising:
verifying a user characteristic and a terminal characteristic of a terminal unit;
providing a service agent satisfying a selected service and the terminal characteristics to the terminal unit when a user selects a specific service through the terminal unit, and generating or updating a user service list to register a user's use of the selected service;
searching the user service list to verify the service being used thereby when there is a request for providing update/re-installation/deletion of the service agent from the terminal unit, and then providing a service agent information list satisfying the verified service and the terminal characteristics of the terminal unit;
providing a service agent to the terminal unit to be updated/re-installed, when the user or the terminal unit selects the service agent to be updated/re-installed, based on the service agent information list; and
updating or deleting the user service list to thus register services so as to avoid using a service corresponding to a deleted service agent when the user or the terminal unit deletes the service agent on the basis of the service agent information list.

2. The method of claim 1, wherein the service list has a structure in which user information and service information are mapped with each other.

3. The method of claim 1, further comprising generating and storing a service agent list stating a list of services that are able to be provided according to a service and the terminal characteristics.

4. The method of claim 2, wherein the service agent list has a structure in which the service information, the terminal characteristics, service agent information and the service agent are mapped with one another, the service agent information including information relating to service agent ID, service agent version and service agent size.

5. The method of claim 4, wherein the providing of the service agent information list includes:
searching the user service list to verify a service being used by the user; and
searching the service agent list, extracting the service agent information satisfying the verified service and the terminal characteristics, generating the service agent information list and then providing the created service agent information list to the terminal unit.

6. The method of claim 1, wherein the registering of the user's use of the selected service includes:
searching the user service list when the user selects the specific service through the terminal unit;
providing the service agent satisfying the selected service and the terminal characteristics when there is no user service list, and subsequently, generating a new user service list having information of the user's selected service; and
providing the service agent in consideration of the selected service and the terminal characteristics when the user service list is present, and then, adding the selected service information to the user service list.

7. A method of providing a service agent for a terminal unit, the method comprising:
providing user characteristics and terminal characteristics to a server, and subsequently receiving a service agent information list satisfying the user characteristics and terminal characteristics; and
when a service agent to be updated/re-installed is selected based on the service agent information list, notifying the server of the selection and receiving the service agent to be updated/re-installed from the server to then update/re-install the received service agent; and
when a service to be newly installed is selected, notifying the server of the selection and receiving a service agent satisfying the newly installed service and the terminal characteristics from the server to thus install the received service agent.

8. The method of claim 7, wherein the receiving and updating of the service agent includes:
comparing a version of a service agent included in the service agent information list with a version of a service agent pre-installed in the terminal unit;
selecting a service agent necessary for an updating operation to thus notify the selection by reflecting a comparison result; and
receiving the service agent necessary for the updating operation from the server to thus update the received service agent.

9. A server comprising:
a user service list storage unit storing a list of services being used by each user;
a service agent storage unit storing a list of service agents able to be provided according to each service and individual terminal characteristics;
a connection management unit supporting a terminal connection and verifying user characteristics and terminal characteristics information from a terminal unit;
an agent manager providing the service agent in consideration of the user characteristics information, the terminal characteristics information, and a service requested by the terminal unit; and
a service manager generating the service list and the service agent list and reflecting an operation of the agent manager in the service list.

10. The server of claim 9, wherein the service agent list has a structure in which service information, the terminal characteristics, service agent information and the service agent are mapped with each other, the service agent information including information on service agent ID, service agent version and service agent size.

11. The server of claim 9, wherein the user service list has a structure in which user information and service information are mapped with each other.

12. The server of claim 9, wherein when the user or the terminal unit selects a specific service, the agent manager acquires and provides the service agent based on the service information and the terminal characteristics of the terminal unit, when the terminal unit requests a service agent information list, the agent manager extracts the service agent information corresponding to all services included in the user service list and the terminal characteristics, from the service agent list, to thus create and provide the service agent information, and when the user or the terminal unit selects a service agent to be updated/re-installed by using the service agent information list, the agent manager acquires and provides the service agent to be updated/re-installed.
